(19) United States
(12) Patent Application Publication
(10) Pub. No.: US 2013/0089385 A1
(43) Pub. Date: Apr. 11, 2013

(54) COLLET CHUCK

(71) Applicant: GUEHRING OHG, Albstadt (DE)

(72) Inventor: Lutfi BOZKURT, Winterlingen (DE)

(73) Assignee: GUEHRING OHG, Albstadt (DE)

(21) Appl. No.: 13/630,101

(22) Filed: Sep. 28, 2012

Related U.S. Application Data
(63) Continuation of application No. PCT/EP2011/055223, filed on Apr. 4, 2011.

(30) Foreign Application Priority Data
Apr. 3, 2010 (DE) 10 2010 014 011.2
Apr. 8, 2010 (DE) 10 2010 014 186.0
Apr. 1, 2011 (DE) 10 2011 001 742.9

(51) Int. Cl. B23B 31/20; B23C 5/26; B23D 77/00

(52) U.S. Cl. CPC B23B 31/20; B23D 77/00; B23C 5/26; B23B 31/208
USPC 408/147; 279/142; 279/43.1; 279/156

(57) ABSTRACT

The description shows a collet chuck 303 for clamping a tool for the purpose of machining a workpiece, comprising: a cutout for receiving a collet 301, wherein the collet chuck 303 has a cutting edge 306 for machining the workpiece.

### AREA OF THE INVENTION

The present invention relates to a collet chuck for clamping a tool for machining a work piece, a collet for clamping the work piece, and a progressive die for machining a work piece.

### BACKGROUND OF THE INVENTION

Known in prior art are chucks for receiving collets for clamping work pieces, for example mills, drills, reamers, and countersinks. Using collets for clamping work pieces results in a high true running accuracy, even at high speeds for the tools.

### SUMMARY OF THE INVENTION

Machining a work piece in several sequential working operations requires a certain machining time. One way to reduce this machining time can involve simultaneously implementing previously sequential working operations.

Therefore, the object is to provide a possible way of machining a work piece by means of tools clamped with collets, wherein, if several working operations are required, the goal is to allow these working operations to chronologically overlap or intersect.

Provided as a first embodiment of the invention is a collet chuck for clamping a tool for machining a work piece, comprising: A cutout for receiving a collet, wherein the collet chuck exhibits a cutting edge for machining the work piece.

The cutting edge of the collet chuck can consist of PKD or CBN, and be soldered onto or into the collet chuck. In an alternative embodiment, the cutting edge can be designed as a removable disk.

Arranging one, two or however many cutting edges desired on a collet chuck makes it possible to set up a progressive die, so that previously sequential working operations can be executed in such a way as to chronologically overlap.

Provided as a second embodiment of the invention is a collet for clamping a tool, wherein the collet is suitable for insertion into a collet chuck according to one of claims 1 to 3, wherein the collet can be moved along the longitudinal axis of the collet chuck to vary the radial distance between the cutting edge and longitudinal axis.

According to the invention, a collet can be designed in such a way as to perform a dual function. On the one hand, a collet according to the invention can be used for clamping a machining tool, for example a drill, a mill, a reamer or a countersink, so that a high true running accuracy can be ensured, even at high speeds. On the other hand, the collet can be designed as an expanding tool, making it possible to vary the cutting edges of a collet chuck in terms of its radial distance from the longitudinal axis of the collet chuck with the collet inserted. As a result, the radial position of the cutting edges of the collet chuck can be finely adjusted.

Provided as a third embodiment of the invention is a progressive die for machining a work piece, comprising: A tool for machining, a collet according to claim 4, and a collet chuck according to one of claims 1 to 3, wherein the tool can be clamped into the collet chuck by means of the collet.

Provided as a fourth embodiment of the invention is a bushing to be pulled onto a collet chuck, wherein the bushing exhibits one or however many cutting edges desired and/or one or however many T-slots desired.

A bushing to be pulled on provides an easy way to make a cutting head out of a chuck, so that a progressive die can be generated.

Exemplary embodiments are described in the dependent claims.

Provided in an exemplary embodiment is a collet chuck, wherein a cutting edge is situated in proximity to the cutout.

Arranging the cutting edge in a front region of the collet chuck makes it possible to relatively extensively chronologically overlap two machining processes, so that the machining time for a work piece can be shortened.

Provided in another embodiment according to the invention is a collet chuck, wherein the cutting edge is a cutting insert, in particular a replaceable cutting insert, and/or wherein the cutting edge is triangular or quadrangular in design.

The advantage to a cutting insert is that it can be replaced, so that the operational capability of the collet chuck can be restored more quickly given worn cutting edges. Replaceable cutting inserts, whether triangular or quadrangular, can further shorten the period for restoring operational capability.

Another exemplary embodiment of the present invention provides a progressive die, wherein the collet has a fragile design.

A “fragile” design makes it possible to “create space” for arranging one or however many cutting edges and/or T-slots desired on a corresponding collet chuck or progressive die.

Provided according to an exemplary embodiment of the invention is a progressive die, wherein the collet can be shifted along a longitudinal axis of the progressive die to vary the radial distance between the cutting edge and the longitudinal axis.

A collet designed as an expanding tool enables a fine adjustment of the radial position of the cutting edges arranged on the collet chuck.

Provided in another embodiment according to the invention is a progressive die, wherein the progressive die encompasses a sleeve, wherein the sleeve is situated between the collet and collet chuck.

A sleeve between the collet and collet chuck enables a finer adjustment of the radial distance between the cutting edge and the longitudinal axis of the progressive die on the collet chuck, since the sleeve permits a gradual sliding from the collet to the collet chuck.

Provided according to another exemplary embodiment of the present invention is a progressive die, wherein the sleeve consists of copper, brass, plastic, rubber or some other type of plastic material.

Designing the sleeve out of copper, brass, plastic, rubber or some other type of plastic material enables a particularly fine adjustment, since the copper, brass, plastic, rubber or other type of plastic material allows the collet to “slide” in the collet chuck to an especially great extent.

It may be regarded as one idea of the invention to design a collet in such a way, specifically to be fragile, as to leave enough space in the front region of the collet chuck to accommodate one or more cutting edges. In another embodiment, the collet can also be used to vary the cutting edges in terms of their radial distance from the longitudinal axis of the collet chuck.

Of course, the individual features can be combined with each other, which can in part also yield advantageous effects going beyond the sum of individual effects.

### BRIEF DESCRIPTION OF THE DRAWINGS

Additional details and advantages of the invention become evident based on the exemplary embodiments depicted in the drawings. Shown on:

FIG. 1 is a side view of a rotatable collet chuck according to the invention;

FIG. 2 is a front view of the rotatable collet chuck from FIG. 1;

FIG. 3 is another rotatable collet chuck with a collet;

FIG. 4 is a collet;

FIG. 5 is a front view of the collet;

FIG. 6 is another rotatable collet chuck with a clamped-in reamer;

FIG. 7 is a front region of a collet chuck;

FIG. 8 is another front region of a collet chuck;

FIG. 9 is a longitudinal section of a collet chuck with a collet;

FIG. 10 is a longitudinal section of a progressive die;

FIG. 11 is a longitudinal section of a collet chuck;

FIG. 12 is a longitudinal section of a collet;

FIG. 13 is a longitudinal section of another collet chuck with a collet;

FIG. 14 is a longitudinal section of another collet chuck with a collet;

FIG. 15 is a bushing according to the invention to be pulled onto another collet chuck.

### DETAILED DESCRIPTION OF EXEMPLARY EMBODIMENTS

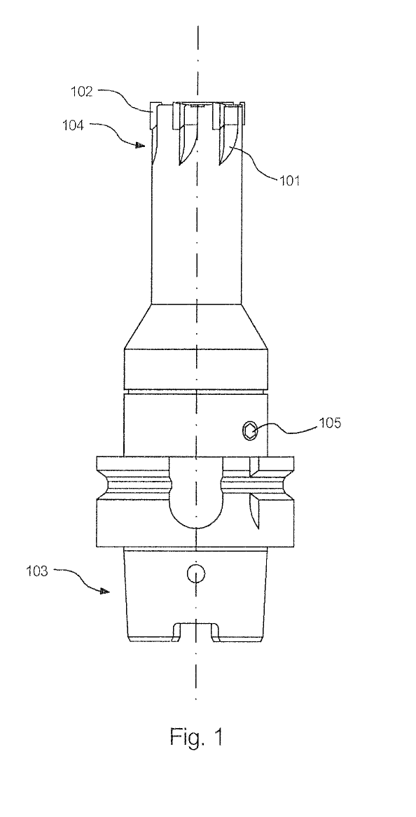

FIG. 1 shows a rotatable cutting tool with a cutting head 104, wherein the cutting head 104 can exhibit cutting edges 102, which can be designed as cutting inserts, and T-slots 101. The rotatable cutting tool is provided with a hollow shank taper intersection 103 to enable coupling to a motor spindle. The cutting tool can exhibit a front cutout for receiving a collet. Therefore, the cutting tool can be used as a collet chuck, wherein a progressive die can be fabricated while clamping a milling tool, for example, into the cutting tool by means of a collet. In an alternative embodiment, a collet according to the invention can be “narrower”, or “less meaty”, or less stable in design, i.e., fragile, meaning that the thickness of the material of the collet from the inner radius to the outer radius is smaller by comparison to collets in prior art, making it possible to open up installation space on the collet chuck. As a result, cutting inserts and T-slots can be arranged on the collet chuck, so that a progressive die can be obtained. The cutting edges 102 can consist of PKD or CBN, and be soldered onto or into the cutting head 104. In an alternative embodiment, the cutting edges 102 can be designed as removable disks.

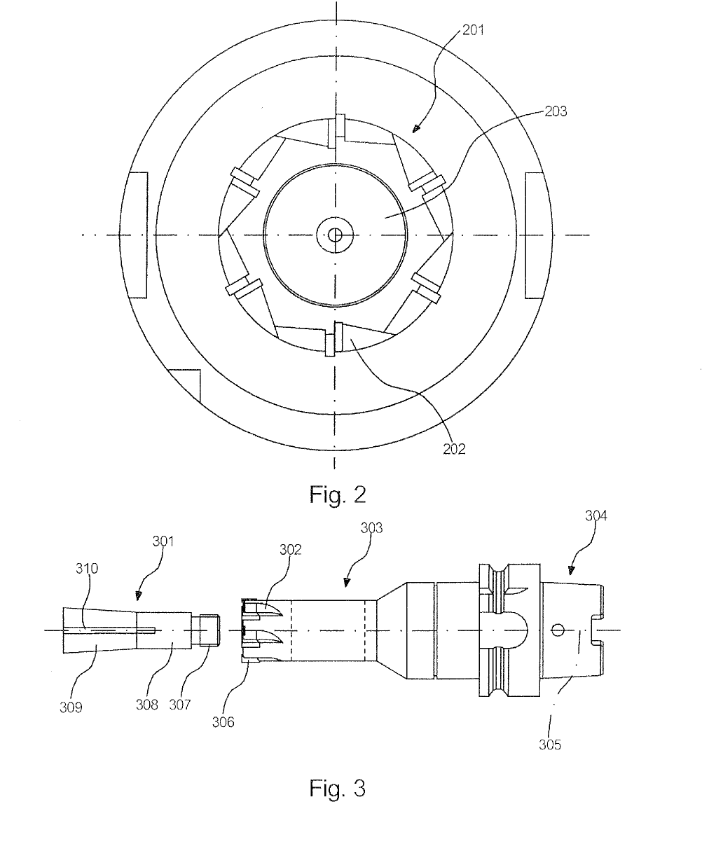

FIG. 2 shows a rotatable cutting tool with a cutting head 201, wherein the cutting head 201 can exhibit cutting edges that can be molded on as cutting inserts 202. Also depicted is a cutout 203, into which a collet can be inserted.

FIG. 3 shows a cutting system with a collet chuck 303, which simultaneously can be used as a cutting tool, wherein the collet chuck 303 can provide cutting inserts 306 and T-slots 302 for machining a work piece. The collet chuck 303 can exhibit a cutout, into which a collet 301 can be introduced. The collet 301 is used to be able to clamp in a tool, for example a drill, a mill, a reamer or a countersink or some other tool. Further depicted is a gap 310, which can be at least partially compressed while clamping in an inserted tool.

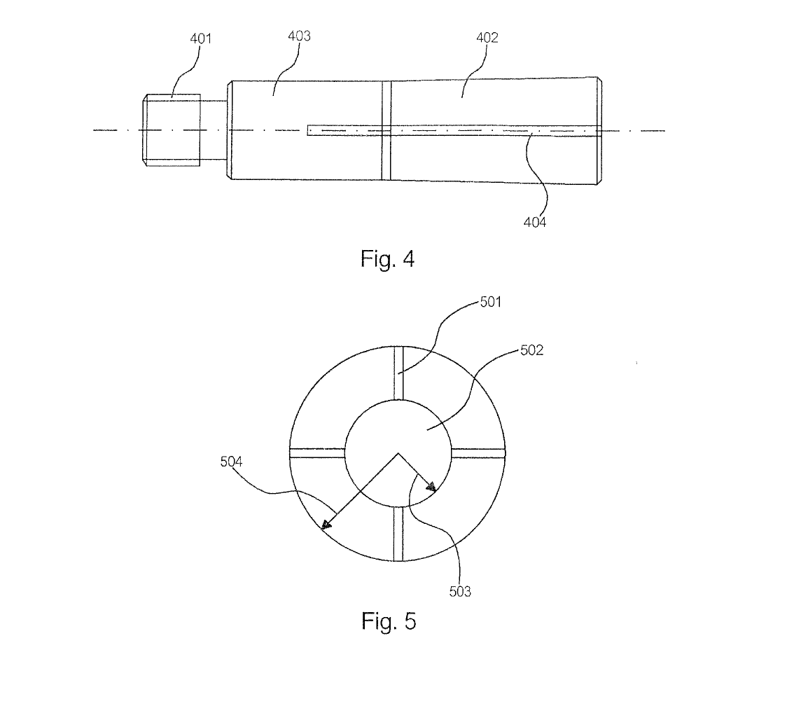

FIG. 4 shows a side view of a collet, wherein a tool, for example a drill, a mill, a reamer, a countersink or some other tool, can be introduced into the collet from the right. The collet exhibits a male thread 401 for fixation inside a collet chuck and a cylindrical section 403. Further depicted is a gap 404, which can be at least partially compressed while clamping in an inserted tool.

FIG. 5 shows a front view of a collet with a cutout 502, into which a tool, for example a drill, a mill, a reamer, a countersink or some other tool, can be inserted, and gaps 501 that can be compressed, making it possible to clamp in the inserted tool. Further depicted is an inner radius 503 and an outer radius 504. According to the invention, the selected difference between the outer radius 504 and inner radius 503 can be relatively small by comparison to collets in prior art, so that the cutout for receiving the collet in a corresponding collet chuck can also be small. As a result, an unobstructed location or space can be obtained on the collet chuck, which can be used for arranging cutting edges and/or T-slots. Therefore, a more fragile embodiment of a collet makes it possible to design a collet chuck as a cutting head. In alternative embodiments, a collet can exhibit four gaps 501 or three gaps.

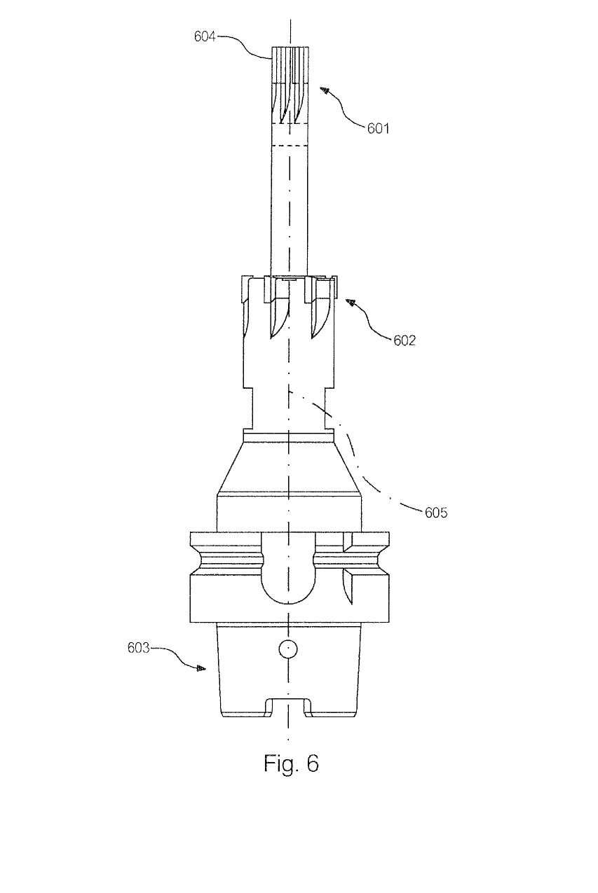

FIG. 6 shows a progressive die, wherein a tool 601, for example a reamer, is situated in a collet, and the collet is clamped in a collet chuck 602. According to the invention, the collet chuck 602 exhibits one or more cutting edges, e.g., cutting inserts, in particular replaceable cutting inserts. Therefore, the collet chuck 602 is designed as a cutting tool according to the invention, so that a progressive die can be obtained overall.

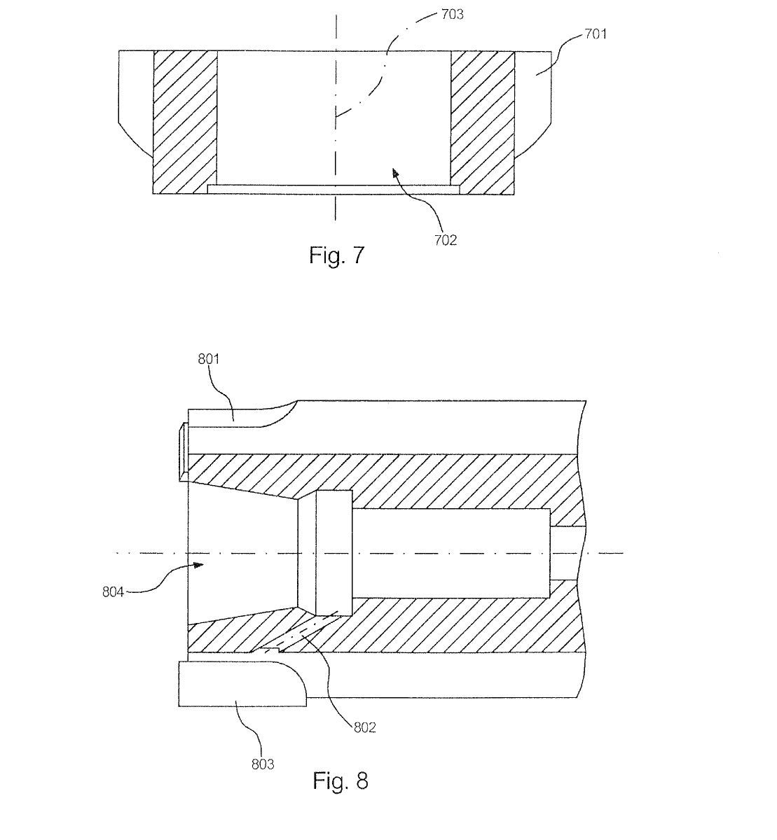

FIG. 7 shows a front region of a collet chuck with a cutout 702 for collets, wherein the collet chuck can exhibit cutting edges 701 according to the invention.

FIG. 8 shows a front region of a collet chuck with a cutout 804 for receiving collets, wherein the collet chuck can exhibit cutting edges 803 and T-slots 801. Further depicted is a coolant channel 802 for supplying the cutting edge 803 with coolant and/or lubricant.

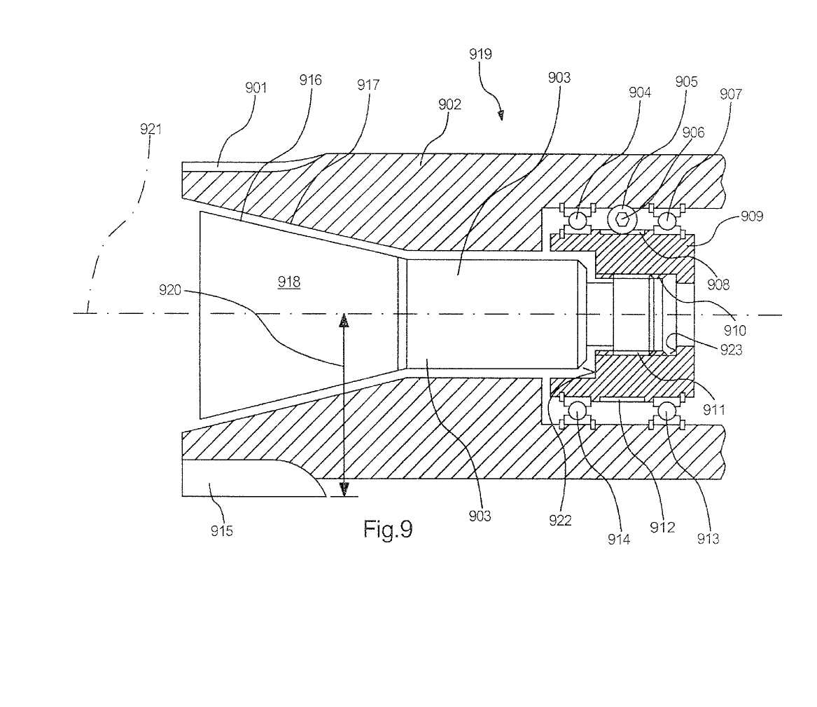

FIG. 9 shows a cutting system with a cutting head 919, which can be used as a collet chuck, and a collet 918. The collet 918 can be used as an expanding tool. The expanding tool 918 can here exhibit an outer cone 916, which can abut against an inner cone 917 of the cutout of the cutting head 919. If the cutting tool/collet 918 is pulled further into the collet chuck/cutting head 919, the radial distance 920 between the cutting edges 915 or cutting inserts and the longitudinal axis 921 situated on the cutting head/collet chuck 919 can be varied, specifically increased. If the collet 918 is shifted further to the left, i.e., removed from the cutout of the cutting head 919, the radial distance 920 between the cutting edges 915 and the longitudinal axis 921 can be diminished. In this way, the radial distance 920 between the cutting edges 915/cutting inserts/T-slots 901 and the longitudinal axis 921 can be calibrated (finely adjusted).

The expanding tool 918 can further exhibit a male thread 911, whose teeth can engage into teeth of a female thread 910. The female thread 910 can be arranged on a worm wheel 909, wherein the worm wheel 909 can be part of a worm gear. The worm gear can encompass the worm wheel 909 with teeth 908, 912 and a worm 905, wherein the teeth of the worm 905 can engage into the teeth 908, 912 of the worm wheel 909. The worm gear can be mounted inside the cutting head 919 by way of roller bearings 904, 907, 913, 914, wherein the roller bearings 904, 907, 913, 914 can be designed as ball bearings. For example, the worm 905 can exhibit a hexagon socket (Allen) 906, a recess, a cross recess, a Torx, a square box or some other intermeshing option. For example, a socket wrench can be inserted into the mesh 906 of the worm 905, wherein the worm 905, and hence also the worm wheel 909, can be rotated or made to rotate by turning the socket wrench. As a result, the expanding tool 918 can be removed toward the left or inserted toward the right, wherein the outer cone 916 of the expanding tool 918 can be pressed against the inner cone 917, making it possible to enlarge the radial distance 920 between the cutting insert 915 and the longitudinal axis 921. The edge 922 of the worm wheel 909 can be used as a stop for the cylindrical section 903 of the expanding tool 918, so as to prevent an overexpansion of the cutting head 919 and a potential breakage. The edge 923 of the worm wheel 909 can be used as a stop for the projection of the expanding tool 918 with its male thread 911. Given the arrangement of a worm gear with its worm wheel 909 and the worm 905, no torque is transmitted to the expanding tool 918. For this reason, the expanding tool 918 can also not end up rotating around its longitudinal axis 921. This eliminates the need for a locking device to prevent oration.

In an alternative embodiment in which additional circumstances make it possible to transmit a torque to the expanding tool 918, a locking device can be situated on the cutting system by virtue of the fact that a pin projects into the recess of the cutting head 919, and can be guided into a groove arranged on the expanding tool 918. This makes it possible to prevent the expanding tool 918 from rotating around its own longitudinal axis 921.

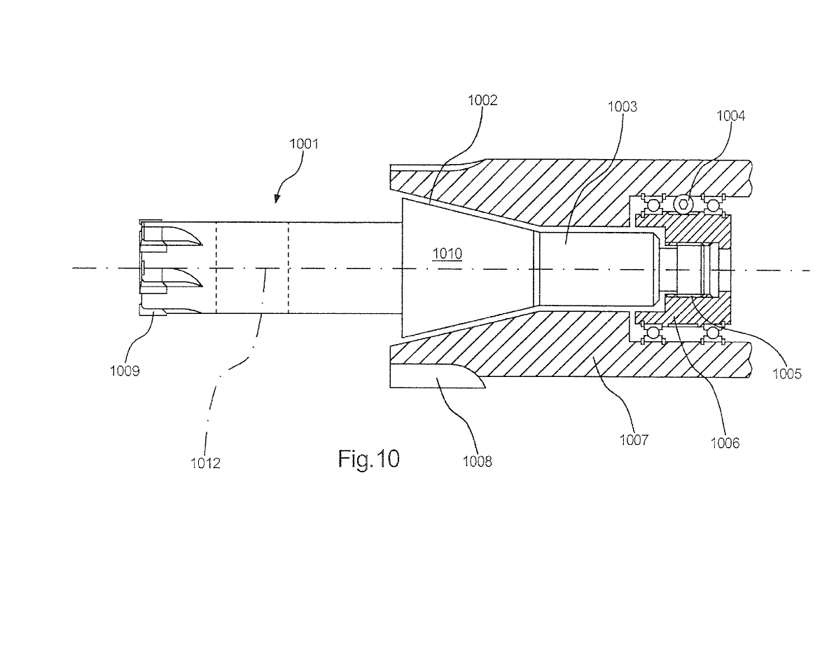

FIG. 10 shows a stepped reamer with first cutting inserts 1008 and second cutting inserts 1009. The reamer 1001 is here clamped into the collet chuck 1007 by means of the collet 1010, wherein the collet chuck 1007 can also exhibit cutting edges 1008 and T-slots, so that the collet chuck 1007 can also act as a cutting head 1007. The collet 1010 can also be used as an expanding tool, so that the radial distance between the cutting edges 1008 of the cutting head 1007 can be adjusted (calibrated).

The radial distance between the first cutting inserts 1008 and the longitudinal axis of the cutting head 1007 can be adjusted with the expanding tool 1010, wherein the expanding tool 1010 can be moved to the left or right by means of a worm gear having a worm wheel 1006 and a worm 1004. If the expanding tool 1010 is moved to the right, the cutting inserts 1008 can be pressed further radially outward. Aside from an outer cone 1002 and a cylindrical section 1003, the expanding tool 1010 can exhibit another cutting head 1001 with additional cutting inserts 1009, so that a two-step reamer can be realized, for example. In an alternative embodiment, another expanding tool with even more reamers can be inserted into the additional reamer, thereby enabling a 3-step reamer. The additional expanding tool can also be designed as a collet. In further alterative embodiments, reamers with as many steps as desired can be provided.

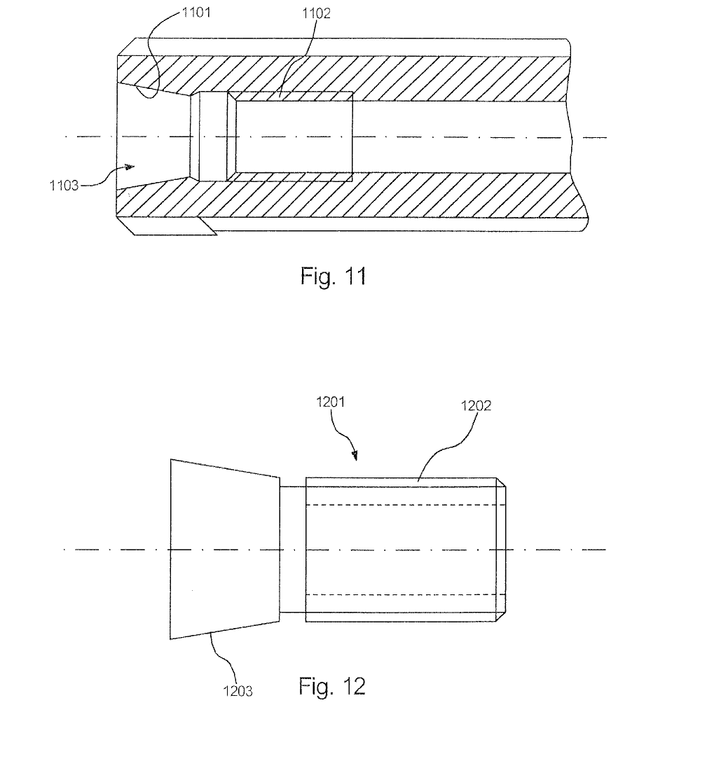

FIG. 11 shows a longitudinal section of the cutting head 1007 on FIG. 10, wherein the cutting head in an alternative embodiment exhibits a cutout 1103, which can encompass an inner cone 1101 and a cylindrical section with a female thread 1102, into which a collect can be inserted.

FIG. 12 shows an expanding tool 1201 with an outer cone 1203 and a cylindrical section with a male thread 1202, wherein the expanding tool 1201 can be inserted into the cutout 1103 of the cutting head on FIG. 11. The male thread 1202 of the expanding tool 1201 can be screwed into the female thread 1102 of the cutting head on FIG. 11, so that the outer cone 1203 can come to lie against the inner cone 1101. The cutting head can be expanded by further screwing the expanding tool 1201 into the cutout 1103 of the cutting head on FIG. 11. The right end of the expanding tool 1201 can exhibit a mesh, e.g., for a socket wrench, so that the expanding tool 1201 can be screwed into the cutting head on FIG. 11, wherein the mesh can be designed as a hexagon socket, for example. In an alternative embodiment, the cutting head of the first step, second step, several steps or all steps in a stepped reamer or some other progressive die can be expanded with an expanding tool according to FIG. 12, wherein the expanding tool can also be designed as a collet according to the invention.

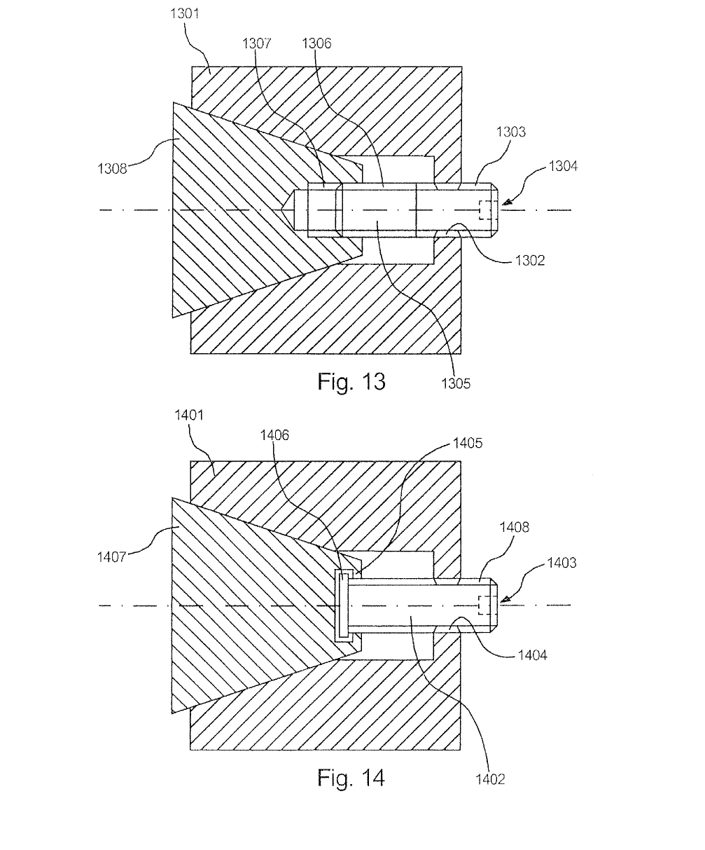

FIG. 13 shows an alternative embodiment of the invention with a threaded bolt 1305 having a differential thread (differentiated thread) on which are located two regions with varying threads 1303, 1306. A first male thread 1306 of the threaded bolt 1305 can engage into a matching female thread 1307 of an expanding tool/a collet 1308, and a second male thread 1303 of the threaded bolt 1305 can engage into a matching female thread 1302 of the cutting head 1301. The male threads 1303, 1306 can exhibit varying pitches. The threaded bolt 1305 can exhibit a hexagon socket 1304, into which a socket wrench can engage, for example. Due to the differing thread types, turning the socket wrench leads to a purely translatory movement of the expanding tool 1308 in the direction of the longitudinal axis of the expanding tool 1308 (no rotation of the expanding tool 1308 around its own axis).

FIG. 14 shows another alternative embodiment of an expanding tool 1407/a collet in a cutting head 1401, wherein the male thread 1408 of a threaded bolt 1402 can engage into the female thread 1404 of the cutting head 1401. The threaded bolt 1402 can exhibit a head 1406 that can be mounted in a cutout of the expanding tool 1407, wherein the head 1406 can be mounted in such a way that the head 1406 can freely rotate inside the cutout. A projection 1405 makes it possible to prevent the head 1406 from jumping out of the cutout. In an alternative embodiment, the head 1406 can be designed as a nose and/or rod-shaped, wherein the head 1406 is always configured in such a way that the projection 1405 can prevent the head 1406 from moving out of the cutout of the expanding tool 1407. The threaded bolt 1402 can exhibit an intermeshing hexagon socket for a socket wrench, wherein the socket wrench can be used to turn the threaded bolt 1402. A rotational motion of the threaded bolt 1402 can lead to a purely translatory movement of the expanding tool 1407 in the direction of the longitudinal axis of the expanding tool 1407, wherein the expanding tool 1407 does not have to rotate due to how the head 1406 is mounted inside the cutout of the expanding tool 1407, which can enable the head 1406 to rotate as desired without taking along the expanding tool 1407.

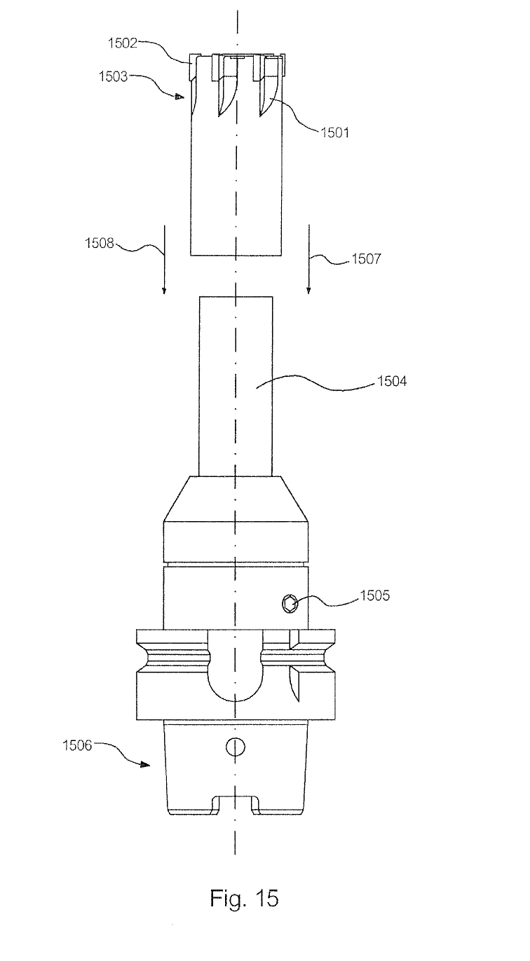

FIG. 15 shows a collet chuck with a receptacle 1504 for collets, which exhibits a mesh 1505, e.g., for a socket wrench, for tightening an inserted collet. A bushing 1503 according to the invention can be pulled onto the receptacle 1504 of the collet chuck (see arrows 1507, 1508), wherein the bushing 1503 can exhibit one or more cutting edges 1502 and/or one or more T-slots 1501.

In another embodiment of the invention, a sleeve can be provided between the hollow shank taper of the cutting head/collet chuck and outer cone of the expanding tool/collet, wherein the sleeve can help improve how the expanding tool and cutting head are able to slide. This enables a more precise and reproducible adjustment of the radial distance between the cutting inserts and the longitudinal axis of the tool. In particular, this makes it possible to prevent the outer cone from hooking the hollow shank taper of the cutting head, so that jerky movements between the expanding tool and cutting head can be avoided. The sleeve can consist of a material that is harder or softer by comparison to the outer cone and/or cutting head. In particular, the sleeve can consist of copper, brass, plastic, rubber or some other type of plastic material. An especially good sliding of the expanding tool and cutting head can be enabled in particular by the selection of sleeve material, wherein copper, brass, plastic, rubber or some other type of plastic material appear to be especially advantageous in this connection. Increasing the conical outer or inner lateral surface of the sleeve also makes it possible to determine how fine or strong a change can be made in the radial distance between the cutting edges of the cutting head and the longitudinal axis. If the outer or inner taper angle is small, a very fine adjustment is possible. A larger taper angle enables a coarse adjustment.

Let it be noted that the term “encompassing” does not preclude other elements or procedural steps, just as the terms “an” and “a” do not rule out several elements and steps.

The used references serve only to enhance understandability, and are in no way be construed as limiting, wherein the claims reflect the protective scope of the invention.

### LIST OF REFERENCE NUMBERS

101 T-slot

102 Cutting edge

103 Hollow shank taper interface

104 Collet chuck

105 Mesh for socket wrench

201 Collet chuck

202 Cutting edge

203 Cutout for receiving a collet

301 Collet

302 T-slot

303 Collet chuck

304 Hollow shank taper interface

305 Longitudinal axis

306 Cutting edge

307 Male thread

308 Cylindrical section

309 Outer cone

310 Gap

401 Male thread

402 Outer cone

403 Cylindrical section

404 Gap

501 Gap

502 Cutout for receiving a tool

503 Inner radius

504 Outer radius

601 Tool

602 Collet chuck

603 Hollow shank taper interface

604 Cutting edge

701 Cutting edge

702 Cutout for receiving a collet

703 Longitudinal axis

801 T-slot

802 Coolant channel

803 Cutting edge

804 Cutout for receiving a collet

901 T-slot

902 Cutting head

903 Cylindrical section

904 Roller bearing

905 Worm

906 Hexagon socket

907 Roller bearing

908 Teeth

909 Worm wheel

910 Female thread

911 Male thread

912 Teeth

913 Roller bearing

914 Roller bearing

915 Cutting edge

916 Outer cone

917 Inner cone

918 Expanding tool/collet

919 Cutting head

920 Radial distance

921 Longitudinal axis

922 Stop

923 Stop

1001 Cutting head

1002 Outer cone

1003 Cylindrical section

1004 Worm

1005 Male thread

1006 Worm wheel

1007 Cutting head

1008 Cutting edge

1009 Cutting edge

1010 Expanding tool/collet

1101 Inner cone

1102 Female thread

1103 Cutout

1201 Expanding tool/collet

1202 Male thread

1203 Outer cone

1301 Cutting head

1302 Female thread

1303 Male thread

1304 Hexagon socket

1305 Threaded bolt

1306 Male thread

1307 Female thread

1308 Expanding tool/collet

1401 Cutting head

1402 Threaded bolt

1403 Hexagon socket

1404 Female thread

1405 Projection

1406 Washer

1407 Expanding tool/collet

1408 Male thread

1501 T-slot

1502 Cutting edge

1503 Bushing

1504 Receptacle for collet

1505 Mesh for socket wrench

1506 Hollow shank taper interface

1507 Pulling-on direction

1508 Pulling-on direction

1. A collet chuck for clamping a tool for machining a work piece, the collet chuck comprising:
a cutout for receiving a collet,
the collet chuck exhibiting a cutting edge for machining the work piece.

2. The collet chuck according to claim 1, wherein the cutting edge is situated in proximity to the cutout.

3. The collet chuck according to claim 1, wherein the cutting edge is a cutting insert, and/or wherein the cutting edge is triangular or quadrangular in design.

4. A collet for clamping a tool, wherein the collet is suitable for insertion into a collet chuck that comprises a cutout for receiving a collet and that exhibits a cutting edge for machining the work piece, wherein the collet can be moved along the longitudinal axis of the collet chuck to vary the radial distance between the cutting edge and the longitudinal axis.

5. A progressive die for machining a work piece, comprising:
a tool for machining;
a collet that is suitable for insertion into a collet chuck that comprises a cutout for receiving a collet and that exhibits a cutting edge for machining the work piece, wherein the collet can be moved along the longitudinal axis of the collet chuck to vary the radial distance between the cutting edge and the longitudinal axis, and
a collet chuck that comprises a cutout for receiving a collet and that exhibits a cutting edge for machining the work piece, wherein the tool can be clamped into the collet chuck by means of the collet.

6. The progressive die according to claim 5, wherein the collet has a fragile design.

7. The progressive die according to claim 5, wherein the collet can be shifted along a longitudinal axis of the progressive die to vary the radial distance between the cutting edge and the longitudinal axis.

8. The progressive die according to claim 5, wherein the progressive die encompasses a sleeve, wherein the sleeve is situated between the collet and collet chuck.

9. The progressive die according to claim 8, wherein the sleeve consists of copper, brass, plastic, rubber or some other type of plastic material.

10. A bushing to be pulled onto a collet chuck, wherein the bushing exhibits one or however many cutting edges desired and/or one or however many T-slots desired.
